(19) United States
(12) Patent Application Publication
(10) Pub. No.: US 2018/0027956 A1
(43) Pub. Date: Feb. 1, 2018

(54) TOOTHBRUSH WITH BUILT-IN TONGUE AND MOUTH CLEANING SYSTEM

(71) Applicant: Steve O'Brien, Sun Valley, NV (US)

(72) Inventor: Steve O'Brien, Sun Valley, NV (US)

(21) Appl. No.: 15/220,305

(22) Filed: Jul. 26, 2016

(51) Int. Cl. A46B 15/00; B08B 1/00; A46B 9/04

(52) U.S. Cl. CPC A46B 15/0081; A46B 9/04; B08B 1/002; B08B 1/005; A46B 2200/1066

(57) ABSTRACT

The present invention is a combination of toothbrush and tongue and mouth cleaner, which allows an individual to brush the teeth with bristles as well as clean the tongue and the interior of the mouth, using one or more clefts embedded on the head of the toothbrush. The apparatus comprises a handle, a head connected to the handle having a front side to which a plurality of bristles is connected. A concave cleft is included on the head of the toothbrush thereby allowing a tongue to be cleaned by scraping the second side of the head against the tongue.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

The present disclosure relates generally to mouth and teeth cleaning apparatus. More specifically, with this device the teeth may be cleaned, as well as the other areas of the mouth, including the tongue, gums, and interior of the cheeks.

### DISCUSSION OF RELATED ART

Dentists commonly advise their patients to vigorously clean the inside of the mouth (particularly, the cheeks, gums, and tongue) in addition o the teeth. Saliva on these surfaces can contain acids and other substances that over time can promote tooth decay. An effective way to remove the saliva and debris is by scraping it with a tongue or mouth cleaner.

Therefore, there is a need for a mouth cleaning apparatus that would allow cleaning of the entire portion of the mouth without much effort. Such a needed device would be simple and less complex in structure. Finally, such a needed device would be cost effective and easily accessible. The present embodiment accomplishes these objectives.

### SUMMARY OF THE DISCLOSURE

The present invention is a combination toothbrush, with tongue and integrated mouth cleaners in the form of elongated concave indentations, clefts. It will have the appearance of a normal toothbrush. This device is a self-contained toothbrush comprising normal bristles but having an easily manufacturable and cleanable indentation or set of indentations, or clefts, that can be used to scrape or otherwise remove saliva and other unwanted substances from the mouth's interior.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a front angled vertical view of a toothbrush head in accordance with the present invention;

FIG. 2 is a lateral view of the toothbrush head in a vertical position, emphasizing a cleaning cleft parallel to the axis in accordance with the present invention;

FIG. 3 is a rear-side view of the device in a vertical position emphasizing the placement of bristles in accordance with the present invention;

FIG. 4 illustrates a rear-side view of the device in a vertical position detailing the head in accordance with the present invention;

FIG. 5 is a top view of the toothbrush head emphasizing one of the clefts used for cleaning in accordance with the present invention;

FIG. 6 illustrates a lateral view of the device in a vertical position profiling a cleaning cleft as a part of front portion of the head in accordance with the present invention; and

FIG. 7 depicts a front angled vertical view of the toothbrush head but, unlike FIG. 1 emphasizing a cleaning cleft as integral to the front of the head in accordance with the present invention.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

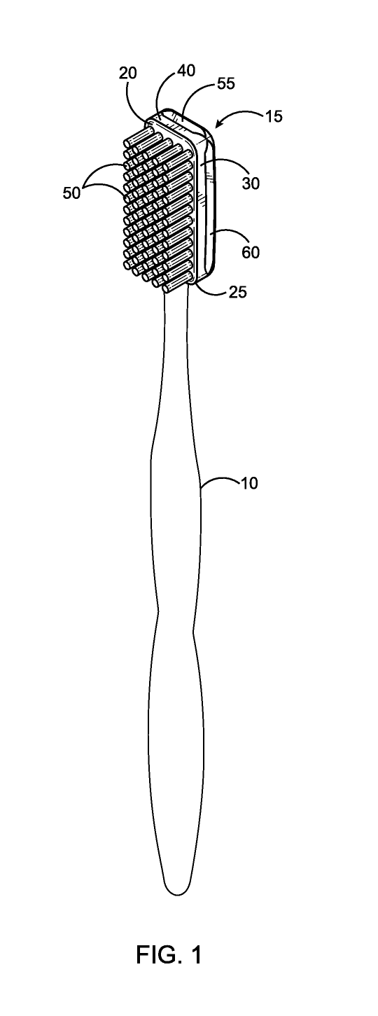

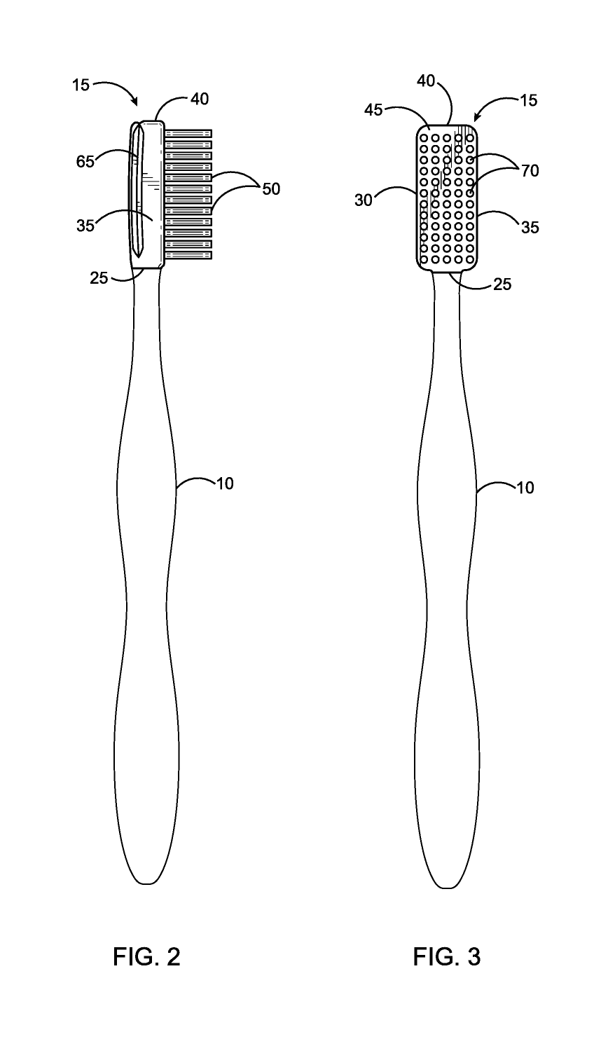

Turning first to FIGS. 1 and 2, a front perspective and a lateral view of a six sided rectanguloid toothbrush head 15 connected to a handle 10 are illustrated respectively. The device in its common modality is a tooth and mouth cleaning instrument comprising a handle 10 from which projects a geometrically shaped head 15 with a plurality of flexible elongated protrusions primarily serving as bristles 50 affixed to a front side 40 of the head 15.

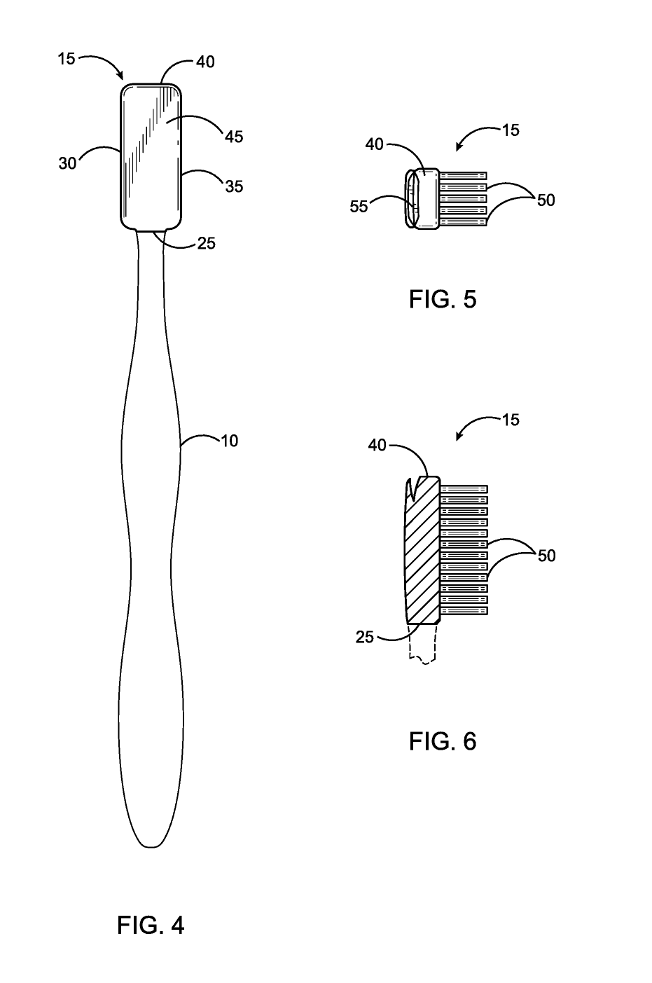

FIGS. 3 and 4 illustrate a rear-side view detailing the toothbrush head and placement of bristles 50, in a vertical position. On the opposite side of the bristles 50 is found a back side 45 of the toothbrush head 15, the surface of which is the location of a concave cleft 70, indicated by diagonally spaced lines and as an aid usually to clean interior surfaces of the mouth, such as the tongue and cheeks.

FIG. 5 shows a top view of the toothbrush head emphasizing one of the clefts and FIG. 6 illustrates a lateral view of the device in a vertical position profiling a cleaning cleft as a part of front portion of the toothbrush head. On the first lateral side 30 of the toothbrush head 15 is located a concave cleft 60 parallel to the longitudinal axis of this toothbrush. On the opposite and second lateral side 35 of the head 15 is located a concave cleft 65 parallel to the longitudinal axis of this toothbrush. At the top side 40 of the head 15 is found the location of a fourth concave cleft 70. This all is to say that in its common modality there is a total of four concave clefts 55, 60, 65, and 70, each used primarily to clean the interior of the mouth, generally by scraping.

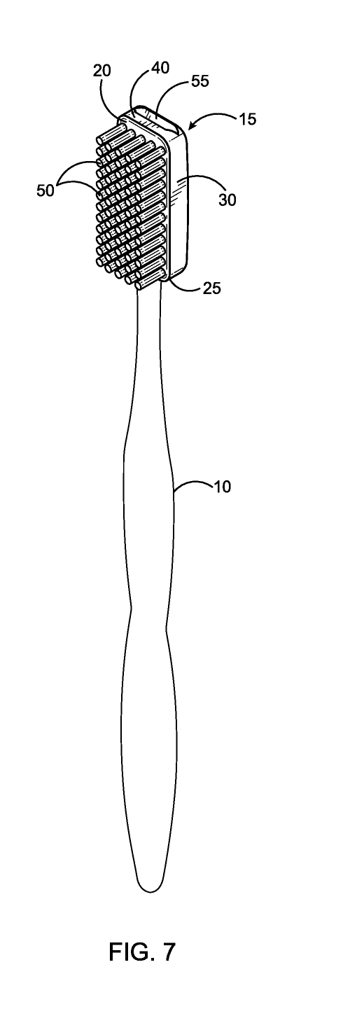

FIG. 7 depicts a front angled vertical view of the toothbrush head 15 but, unlike FIG. 1 emphasizing a cleaning cleft as integral to the front of the head. The common way of using this device is to brush the teeth in a normal way and use any one of the concave clefts to scrape an interior surface of the mouth or tongue, thereby removing saliva, debris, and other unwanted deposits. Especially noteworthy is the ability of the user to employ the clefts located on the lateral sides 35, 40 paralleling the longitudinal axis of the toothbrush for larger surfaces, such as the tongue and interior of the cheeks. A cleft located at the top side 40 of the head 15 enables one to clean a root of the tongue by moving this instrument back and forth against the root in an axis parallel to the length of one's body. Cleaning of a large surface is enhanced by rubbing the concave cleft 70 located on the back side 45 of the head 15 against that surface. After each scraping the user rinses the head of the toothbrush, paying close attention to the cleft employed in the scraping.

There may be variations as to the shape of any of the components, as well as the number, configuration, and location of the clefts. Further stated, there is no restriction on dimensions or proportions of the components or their configuration or their material as long as the basic purpose and functionality is preserved, i.e., cleaning the teeth and tongue with one device. The head 15 of the toothbrush may be of any shape or density or hollow, as long as it contains clefts, ridges, or other irregularities that suffice in scraping the interior of the mouth so as to remove unwanted material, such as saliva and food particles.

This description of this combination tooth brush and tongue cleaner gives a ‘person having an ordinary skill level in the art (35 USC 103(a))’ the ability to create and use the device in the best way possible. There can be variations, equivalents, and combinations of the device, so one should not take the above description as being the only way or form it can be created. That is, this description is but one representation of what can be done to produce the device to perform in the intended manner. Summarized, this invention or its parts may be made of any material, size, shape, color, or weight, as long as the central purpose and function, and basic method of operation are retained, i.e., serve as a tooth brush that can clean teeth in a normal way but also serve as a way of removing unwanted material, such as saliva and food particles from the mouth's interior.

As used herein, the singular forms “a”, “an” and “the” include plural referents unless the context clearly dictates otherwise. “And” as used herein is interchangeably used with “or” unless expressly stated otherwise. As used herein, the term ‘about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

While a particular form of the invention has been illustrated and described, it will be apparent that various modifications can be made without departing from the spirit and scope of the invention. Accordingly, it is not intended that the invention be limited, except as by the appended claims.

1. A toothbrush comprising:
a. a handle;
b. a head connected to the handle, the head having a front side, the front side of the head having plurality of bristles;
c. a concave triangular cleft disposed adjacent to an integral tongue cleaning blade;
d. wherein the concave triangular cleft is deep enough to receive an amount of plaque typically present on a human tongue;
e. wherein the cleft and the blade are located on a second side of the head thereby allowing a tongue to be cleaned by scraping the second side of the head against the tongue.

2. (canceled)

3. The toothbrush of claim 1, wherein the head of the toothbrush is a six-sided rectanguloid including a bottom side, the bottom side being connected to the handle, a top side, a back side oriented opposite the front side, a first lateral side, and a second lateral side.

4. The toothbrush of claim 3, wherein the cleft is located on the top side.

5. The toothbrush of claim 3, wherein the cleft is located on the first lateral side.

6. The toothbrush of claim 3, wherein the cleft is located on the second lateral side.

7. The toothbrush of claim 3, wherein the cleft is located on the back side.

8. The toothbrush of claim 1, wherein the head is ellipsoid in shape.

9. A method of cleaning a tongue comprising the steps of:
a. Providing the toothbrush of claim 1;
b. scraping the second side of the head of the toothbrush along the tongue.

10. The method of claim 9, adapted to clean a root of a tongue:
a. wherein the head of the toothbrush includes a bottom side, the bottom side being connected to the handle, a top side, a back side oriented opposite the front side, a first lateral side, and a second lateral side;
b. wherein the concave cleft is located on the top side of the head of the toothbrush;
c. further comprising the step of pushing the toothbrush back into a mouth to access the root of the tongue.

11. A method of cleaning an interior surface of a mouth comprising the steps of:
a. providing a toothbrush having a handle; a head connected to the handle, the head having a first side, the first side of the head having plurality of bristles; and a concave cleft located on a second side of the head;
b. scraping the second side of the head of the toothbrush along the interior surface of the mouth.
c. further comprising the step of pushing the toothbrush back into a mouth to access the root of the tongue.
